(19) United States
(12) Patent Application Publication
(10) Pub. No.: US 2013/0091517 A1
(43) Pub. Date: Apr. 11, 2013

(54) METHOD AND APPARATUS OF PROVIDING BROADCAST CONTENT AND METADATA FOR AUGMENTED BROADCASTING, METHOD AND APPARATUS OF PROVIDING AUGMENTING CONTENT, AND METHOD AND APPARATUS OF RECEIVING AUGMENTED BROADCAST CONTENT

(71) Applicant: Electronics and Telecommunications Research Institute, Daejeon-si (KR)

(72) Inventors: Jeoung Lak HA, Daejeon-si (KR); Soon Choul KIM, Daejeon-si (KR); Seung Chul KIM, Daejeon-si (KR); Jung Hak KIM, Daejeon-si (KR); Bum Suk CHOI, Daejeon-si (KR); Young Ho JEONG, Daejeon-si (KR); Jin Woo HONG, Daejeon-si (KR)

(73) Assignee: Electronics and Telecommunications Research Institute, Daejeon-si (KR)

(21) Appl. No.: 13/646,123

(22) Filed: Oct. 5, 2012

(30) Foreign Application Priority Data
Oct. 7, 2011 (KR) 10-2011-0102634

(51) Int. Cl. H04N 21/23; H04N 21/25; H04N 21/232

(52) U.S. Cl. 725/30; 725/115; 725/116

(57) ABSTRACT

In a method of receiving augmenting content, broadcast content and augmenting content are received from a broadcast content providing apparatus, metadata related to the broadcast content is interpreted to check an indicator indicating such that augmenting content are applicable, and augmenting content are requested from an augmenting content providing apparatus by using access information of the augmenting content providing apparatus. Thereafter, augmenting content are received from the augmenting content providing apparatus, and augmenting content received in the augmenting content receiving step are synchronized with the broadcast content and output to a temporal/spatial region corresponding to display region information included in the metadata or the display region information is transmitted to a separate output device. Thus, a viewer can conveniently receive area information-based augmenting content in the form of large capacity multimedia including a graphic image or video without having to perform searching.

### CROSS-REFERENCE TO RELATED APPLICATIONS

This application claims the benefit of priority of Korean Patent Application No. 10-2011-0102634 filed on Oct. 7, 2011, all of which are incorporated by reference in their entirety herein.

### BACKGROUND OF THE INVENTION

1. Field of the invention

The present invention relates to a method of providing additional information in broadcasting broadcast content and, more particularly, to a method of providing different types of information in respective local areas and an apparatus of performing the same.

2. Related Art

In a communication network, a user's location in a cellular or wireless LAN or in the Internet may be known, based on which various location-based services may be provided. IPs may be grouped by area by using Internet facility information to obtain location information of each user IP, or location information of an Internet terminal may be obtained by mapping static information such as location information regarding respective ports of network facilities and dynamic information such as an IP address, a MAC address, and ‘DHCP’ information allocated to an Internet terminal connected to a wired Internet. Also, in case of a wireless LAN (Wi-Fi), when positioning is required, a location may be recognized by using a MAC and a field strength of a Wi-Fi AP installed nearby. Besides, a location of a terminal may be measured in various manners, such as through a GPS or a triangulation method using a cell ID or cells in a cellular system, or the like. Various communication services may be provided according to a measured location of a terminal. However, in case of a broadcast service, a broadcast program is separately produced and broadcast by local stations, but more specific location information than that provided by each local station cannot be reflected to be included in a broadcast program. For example, in case of advertising a pizza brand, if an advertisement program thereof is created generally based on the Seoul area and broadcast, the same information is viewed from all over the country. Thus, a broadcast viewer is provided with only general information regardless of an area where he or she is located, and in order to obtain detailed information, the user should directly search for information through a separate means.

### SUMMARY OF THE INVENTION

The present invention provides a method of providing broadcast content and metadata, a method of providing augmenting content, and a method of receiving augmenting broadcast content and metadata capable of displaying augmenting content based on area information according to an area in which a receiving apparatus is located by designating a particular region of broadcast content.

The present invention also provides an apparatus of providing broadcast content and metadata, an apparatus of providing augmenting content, and an apparatus of receiving augmenting broadcast content capable of displaying augmenting content based on area information according to an area in which a receiving apparatus is located by designating a particular region of broadcast content.

Technical subjects of the present invention are not limited to the foregoing technical subjects and any other technical subjects not mentioned herein will be clearly understood by a skilled person in the art from the following description.

In an aspect, a method of providing broadcast content and metadata to a receiving apparatus is provided. The method includes: generating metadata for displaying area information-based augmenting content related to broadcast content (Here, being related refers to a formal relevancy; namely, it does not mean that substance of broadcast content and that of augmenting content are necessarily directly related); generating a broadcast content stream based on the broadcast content; generating an additional data stream based on the metadata; and transmitting the broadcast content stream and the additional data stream to the receiving apparatus. The metadata may include at least one of an indicator indicating such that the broadcast content applies augmenting content; access information of an augmenting content providing apparatus for transmitting the area information-based augmenting content to the receiving apparatus; display region information indicating a temporal/spatial region on which the area information-based augmenting content are displayed on the broadcast content; and basic augmenting content to be output when the area information-based augmenting content corresponding to an area in which the receiving apparatus is located do not exist. In the transmitting of the broadcast content stream and the additional data stream to the receiving apparatus, the broadcast content stream and the additional data stream may be multiplexed and transmitted.

In another aspect, a method of providing augmenting content is provided. The method includes: a step of receiving an augmenting content request requesting area information-based augmenting content from a receiving apparatus; a step of checking applied broadcast content information requesting the augmenting content by interpreting the augmenting content request; an augmenting content searching step of searching a storage unit for the area information-based augmenting content with respect to an area in which the receiving apparatus is located based on the checked applied broadcast content information; and an augmenting content transmitting step of transmitting the searched augmenting content to the receiving apparatus. The method may further include: a user verifying step of receiving log-in information from the receiving apparatus and analyzing the log-in information to verify a user, the log-in information including at least one of a user ID, a password, an authorization certificate; and an error transmitting step of transferring an error message to the receiving apparatus when the user verification fails in the user verifying step. The storage unit may include at least one areal augmenting content category obtained by classifying the area information-based augmenting content by areas, and the areal augmenting content category includes at least one individual augmenting content information belonging to a corresponding area of the areal augmenting content category, and the individual augmenting content information may include at least one of: broadcast content information including a broadcast content ID for identifying the broadcast content to which the area information-based augmenting content are applied, and augmenting content ID; area information-based augmenting content applied to the broadcast content; and metadata including information required for outputting the area information-based augmenting content. The storage unit may include at least one areal augmenting content category obtained by classifying the area information-based augmenting content by areas, and at least one of the areal augmenting content categories may include access information of an areal augmenting content providing apparatus providing corresponding area information-based augmenting content, the areal augmenting content providing apparatus includes at least one individual augmenting content information belonging to a corresponding area of the areal augmenting content category, and the individual augmenting content information may include at least one of: broadcast content information including a broadcast content ID for identifying the broadcast content to which the area information-based augmenting content are applied, and augmenting content ID; area information-based augmenting content applied to the broadcast content; and metadata including information required for outputting the area information-based augmenting content.

In still another aspect, a method of receiving augmenting content based on area information is provided. The method includes: a broadcast content receiving step of receiving broadcast content and metadata from a broadcast content providing apparatus; a metadata interpreting step of interpreting the metadata related to the broadcast content and checking an indicator indicating such that augmenting content are filled; an augmenting content requesting step of requesting augmenting content from an augmenting content providing apparatus based on access information of augmenting content providing apparatus included in the metadata when the augmenting content indicator exists; an augmenting content receiving step of receiving the augmenting content from the augmenting content providing apparatus; a content synchronizing step of synchronizing the broadcast content received in the broadcast content receiving step and the augmenting content received in the augmenting content receiving step; and a content output step of outputting the synchronized broadcast content and augmenting content to a temporal/spatial region corresponding to a display region information included in the metadata or transmitting the display region information to a separate output device.

### BRIEF DESCRIPTION OF THE DRAWINGS

FIG. 1 is a flow chart illustrating a process of a broadcast providing method of a digital broadcasting system to which an embodiment of the present invention is applied.

FIG. 2 is a conceptual view of the digital broadcasting system obtained by reconfiguring respective steps from a view point of a broadcast service participant.

FIG. 3 is a view illustrating relationships between broadcast service participants embodying the concept of FIG. 2.

FIG. 4A is a flow chart illustrating a process of a broadcast content and metadata providing method according to an embodiment of the present invention.

FIG. 4B is a view illustrating a configuration of a broadcast content transport stream illustrated in FIG. 4A.

FIG. 5 is a flow chart illustrating a process of an augmenting content providing method according to an embodiment of the present invention.

FIG. 6 is a view illustrating a storage unit of the augmenting content providing apparatus for providing augmenting content by areas according to an embodiment of the present invention.

FIG. 7 is a detailed view illustrating individual augmenting content information of FIG. 6.

FIG. 8 is a view illustrating the configuration of the storage unit when the apparatus of FIG. 6 provides access information.

FIG. 9 is a view illustrating a storage unit of an augmenting content providing apparatus for providing augmenting content by broadcast content according to another embodiment of the present invention.

FIG. 10 is a detailed view illustrating individual augmenting content information of FIG. 9.

FIG. 11 is a view illustrating the configuration of a storage unit when the apparatus of FIG. 9 provides access information.

FIG. 12 is a flow chart illustrating a process of an augmenting content receiving method according to an embodiment of the present invention.

FIG. 13A is a view illustrating a configuration of a broadcast content providing apparatus according to an embodiment of the present invention.

FIG. 13B is a view illustrating a configuration of an augmenting content providing apparatus according to an embodiment of the present invention.

FIG. 14 is view illustrating a configuration of an augmenting broadcast content receiving apparatus according to an embodiment of the present invention.

FIG. 15 is a view illustrating a configuration of user information applied to a storage unit and an input unit of FIG. 14.

FIG. 16 is a view illustrating a configuration of an apparatus that synthesizes broadcast content and augmenting content and outputs the same.

FIG. 17 is a flow chart illustrating a process of a method of providing additional content based on area information.

FIG. 18 is a flow chart illustrating a process of a method of determining whether to output augmenting broadcast content according to reception of metadata.

### DESCRIPTION OF EXEMPLARY EMBODIMENTS

Since the present invention may be variously modified and have several exemplary embodiments, specific exemplary embodiments will be shown in the accompanying drawings and be described in detail.

However, it is to be understood that the present invention is not limited to the specific exemplary embodiments, but includes all modifications, equivalents, and substitutions included in the spirit and the scope of the present invention.

Further, in describing exemplary embodiments of the present invention, well-known functions or constructions will not be described in detail since they may unnecessarily obscure the understanding of the present invention.

Terms used in the specification, ‘first’, ‘second’, etc., may be used to describe various components, but the components are not to be construed as being limited to the terms. That is, the terms are used to distinguish one component from another component. Therefore, the first component may be referred to as the second component, and the second component may be referred to as the first component. The term ‘and/or’ includes a combination of a plurality of items or any one of a plurality of terms.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

In addition, components described in exemplary embodiments of the present invention are independently shown only in order to indicate that they perform different characteristic functions. Therefore, the components that are independently shown do not mean that each of the components may not be implemented as one hardware or software. That is, each of the components is divided for convenience of explanation, a plurality of components may be combined with each other to thereby be operated as one component or one component may be divided into a plurality components to thereby be operated as the plurality of components, which are included in the scope of the present invention as long as it departs from essential characteristics of the present invention.

Unless indicated otherwise, it is to be understood that all the terms used in the specification including technical and scientific terms has the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

To begin with, an outline of a smart TV and augmenting broadcasting will be described.

A smart TV simultaneously provides an Internet function in an existing digital TV broadcast broadcasting system, allowing viewers (or users) to execute content or applications on the Internet as well as TV viewing or online searching. A smart TV allows users to use broadcast services through a broadcasting network and various content on the Internet through wired/wireless Internet. Also, a smart TV operates as a hub of various digital devices in homes.

Moving away from uni-directional viewing of broadcast content provided from broadcasters for the conventional digital TV broadcasting, augmenting broadcasting refers to naturally integrating augmenting content to enhance viewers' sense of reality and liveliness and allowing a viewer to select a service provided by a desired augmenting content provider as well. To this end, a TV and a portable reception terminal (referred to as ‘receiving apparatuses’, hereinafter) are to receive the conventional broadcast program (referred to as ‘broadcast content’, hereinafter) beamed from a broadcaster and augmenting content capable of augmenting the broadcast content. The broadcaster may beam augmenting content related to broadcast content and augmenting service related metadata together with a broadcast program.

As an example of augmenting broadcasting, a broadcaster may show detailed information of a relevant anatomical chart, as augmenting content, on a TV program provided in the form of broadcast content. A viewer may view detailed information regarding respective organs or three-dimensional (3D) graphic images of respective organs together. In case of 3D graphic information, the viewer may turn the information at various angles to view the same. In particular, the augmenting content may not be output according to a user selection and the user may enjoy only conventional broadcast content.

For augmenting broadcasting, augmenting content are required to be produced together when broadcast content are produced, and metadata including information regarding an output time, an output position, a processing event, and the like, of augmenting content is required to be produced together with broadcast content. When broadcast content are produced, an augmenting broadcast authoring tool serves to effectively generate metadata, and a multiplexer and a broadcast content providing apparatus serve to multiplex generated metadata together with a broadcast program and beam the same. An augmenting broadcast content receiving apparatus such as a smart TV, or the like, outputs a broadcast program, secures relevant augmenting content based on metadata, and provides the augmenting content in line with the broadcast content to the viewer according to a rule defined in the metadata. The augmenting content may be stored in an auxiliary memory device (referred to as a ‘storage unit’, hereinafter) of the receiving apparatus, or may be provided by a certain content provider on the Internet, and pertinent information is provided by using metadata.

An augmenting broadcasting system may transmit and receive broadcast content, metadata, and augmenting content through a broadcasting network, and transmit and receive metadata and augmenting content through a communication network. In order to use a broadcasting network and a communication network, the three following methods may be used.

1) Augmenting content together with metadata besides broadcast content may be transmitted via the broadcasting network, and a receiving apparatus receives the same so as to be provided with augmenting broadcasting, 2) only broadcast content and metadata are sent via the broadcasting network and the receiving apparatus receives pertinent augmenting content in a communication network so as to receive an augmenting broadcast, and 3) only broadcast content and metadata are sent via the broadcasting network and the receiving apparatus receives pertinent additional metadata and augmenting content in a communication network so as to receive an augmenting broadcast.

The receiving apparatus may approach a URL or a URI based on the metadata received from the broadcasting network to receive relevant augmenting content or metadata and augmenting content according to two following methods.

1) When the receiving apparatus approaches a URL or URI, pertinent augmenting content or metadata, pertinent augmenting content or metadata and augmenting content may be immediately transferred to the receiving apparatus, or 2) when the receiving apparatus approaches a URL or URI, a user may select any one of various augmenting content or metadata or augmenting content in a format of a homepage, or the like.

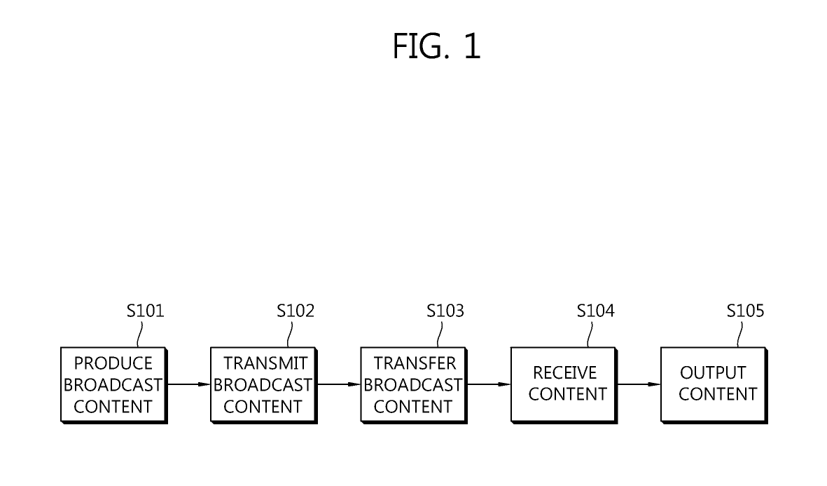

A method of providing augmenting content based on area information in an augmenting broadcasting environment as mentioned above will be described. FIG. 1 is a flow chart illustrating a broadcast providing method of a digital broadcasting system. In referring to reference numerals used in the accompanying drawings, reference numerals 000-1, 000-2, . . . 000-n denote elements having the same form, and reference numeral 000 is used to designate all of 000-1, 000-2, . . . 000-n.

As illustrated in FIG. 1, broadcast content are produced in a producing step S101, beamed in a beaming step S102, and transferred to respective viewers in a transmitting step S103, and the broadcast content are received by receiving apparatuses of the viewers in a receiving step S104 and output in an outputting step S105 through a display or a speaker. For area information augmenting broadcasting, information regarding augmenting content, besides the broadcast content, and metadata representing a relationship between the two content are produced together in the producing step S101. In the beaming step S102, broadcast content or augmenting content are changed into a format that can be transmitted according to a transmission scheme in the transmitting step S103. In the transmitting step S103, a transmission network first assumes a broadcasting network, and relay station may perform relaying. Also, the transmission network is not limited to a traditional broadcasting network type, and may transmit broadcast content through a communication network, like the case of an IPTV, or the like. Even when the transmission network assumes a broadcasting network, the transmission network includes also a communication network together in order to transmit augmenting content, and may include a different output unit besides a display or a speaker in the output step S105. Transmitted and received content undergo processes such as encoding/decoding, error-correction and modulation/demodulation, and here, these procedures are not directly related to the characteristics or features of the present invention, so a description thereof will be omitted.

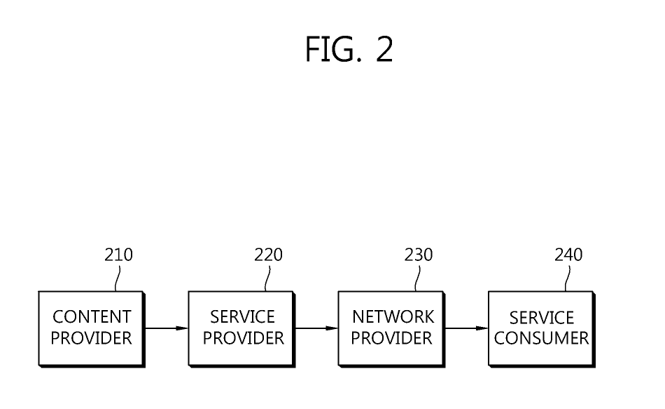

FIG. 2 is a conceptual view of a digital broadcasting system obtained by reconfiguring respective steps from a view point of a broadcast service participant.

As shown in FIG. 2, a content provider 210, who sells, or the like, broadcast content to provide broadcast content, may directly participate in producing broadcast content or re-sells produced broadcast content. Broadcast content may be produced by an independent content producing enterprise or an individual. As for re-selling of broadcast content, produced broadcast content are collected and directly sold to a service provider 220 or a service consumer 240. The service provider 220, who provides a broadcast service, schedules broadcast content according to a broadcast schedule and delivers the scheduled broadcast content to viewers. The network provider 230 serves to transmit content by using a transmission path along which broadcast content are transmitted. A used network includes a wired/wireless communication network as well as a broadcasting network. The service consumer 240 as a viewer or a user uses a broadcast service or broadcast content. A receiving apparatus used by the service consumer 240 may perform both the reception step S104 and the output steep S105. A single operator may combine the content provider 210 and the service provider 220 (namely, a single operator may be the content provider 210 and service provider 220), and also, a single operator may combine the service provider 220 and the network provider 230. In many cases, conventional broadcasters include these three types of services.

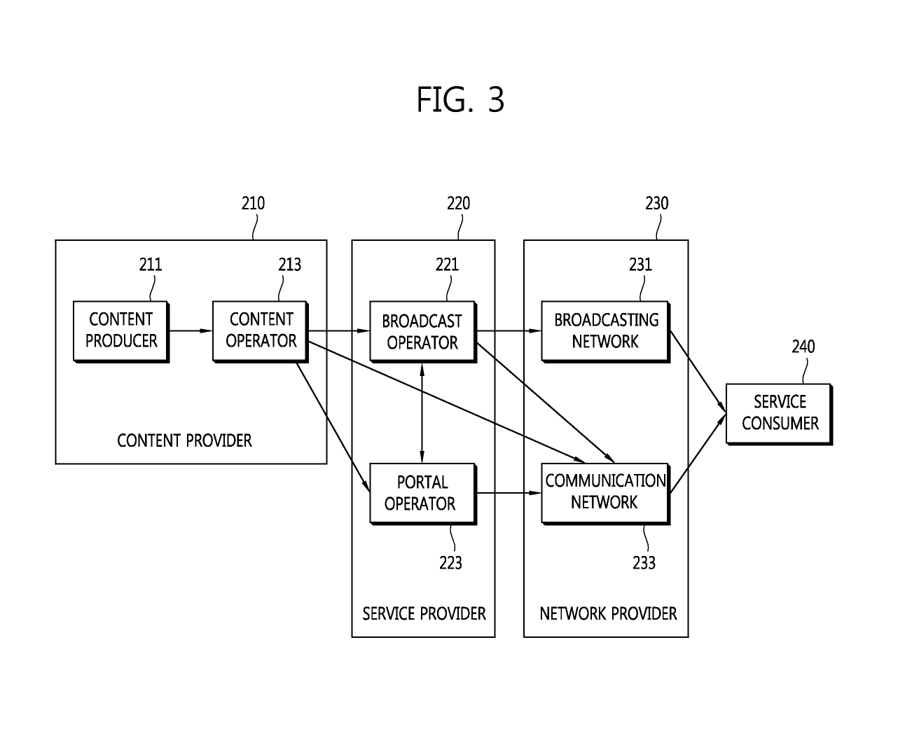

FIG. 3 is a view illustrating relationships between broadcast service participants embodying the concept of FIG. 2.

In FIG. 3, relationships between or among the content provider 210, the service provider 220, and the network provider 230 are described again, and the content provider 210, the service provider 220, and the network provider 230 establish relationships in which a plurality of participants are complicatedly involved in an N:N:N manner. In an embodiment of the present invention, an application of a smart TV capable of additionally providing information, not supported by a broadcasting network 231, by using a wired/wireless communication network 233, or bi-directional broadcasting is taken into consideration. The content provider 210 include one or more content providers 213, and these content providers 213 cooperate with one or more content producers 211. The service provider 220 may include a broadcast operator 221 or a portal provider 223. The broadcast operator 221 may receive broadcast content from one or more content operators 213 or may directly produce broadcast content to provide a broadcast service. The broadcast content may be provided via the broadcasting network 231 and augmenting content for area information may be provided via the wired/wireless communication network 233. The network provider 230 may provide the broadcasting networks 231 or the communication network 233, respectively, and these broadcasting network 231 or the communication network 233 provides a path allowing the broadcast operator 221, the content operator 213, and the portal operator 223 to provide broadcast content therealong to the service consumer 240. The portal operator 223 may provide augmenting broadcast content directly to the service consumer 240 based on a contract with the broadcast operator 221 and the content operator 213, or provide information regarding the content operator 213 having the corresponding augmenting broadcast content to the service consumer 240, thus allowing the service consumer 240 to receive the augmenting broadcast content from the corresponding content operator 213. The augmenting broadcast content provided to the service consumer 240 directly from the portal operator 223 or through the content operator 213 may be provided via the wired/wireless communication network 233. Augmenting content for area information to be shown with respect to respective broadcast content may be received from the each portal operator 223 or content operator 213. Namely, in a single area, area information of a program called PA may be received from an operator called CPA and area content of a program called PB may be received from an operator called CPB.

Embodiments of the present invention will be described in detail with reference to the accompanying drawings.

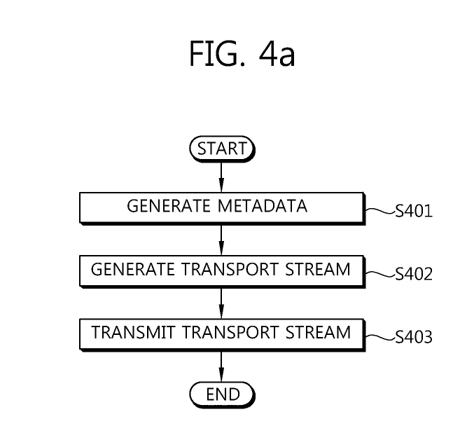

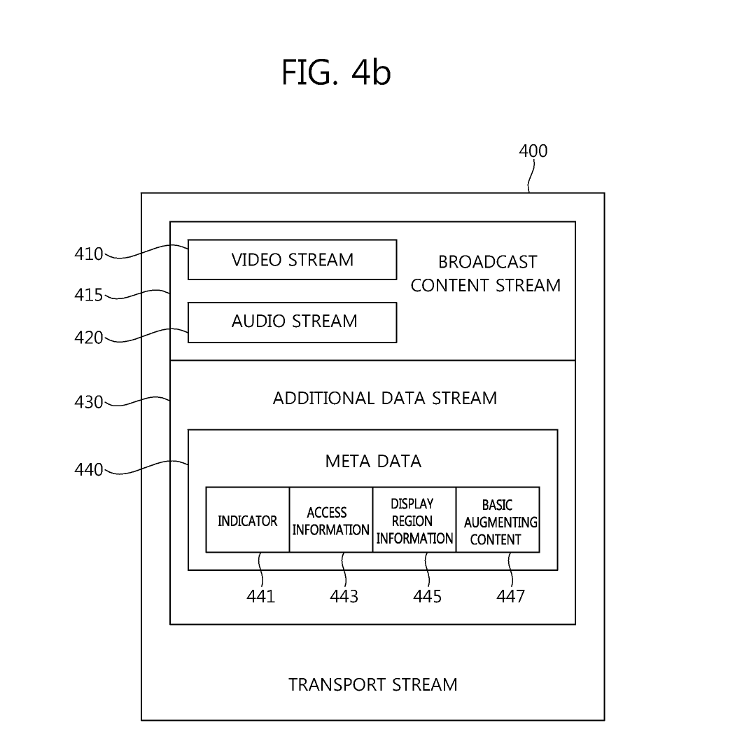

FIG. 4A is a flow chart illustrating a process of a broadcast content and metadata providing method according to an embodiment of the present invention. FIG. 4B is a view illustrating a configuration of a broadcast content transport stream illustrated in FIG. 4A.

As illustrated in FIG. 4A, in a broadcast content and metadata transmission method, first, metadata for displaying area information-based augmenting content related to broadcast content is generated (S401). Here, the area information-based augmenting content are content related to the corresponding broadcast content. Namely, the area information-based augmenting content refer to more specific augmenting content optimized for an area in which a receiving apparatus is located. Next, a broadcast content stream is generated based on the broadcast content. The broadcast content stream may be split into an audio stream and a video stream according to circumstances. And then, an additional data stream is generated based on the metadata (S402). As shown in FIG. 4B, a transport stream 400 may include a broadcast content stream 415 and an additional data stream 430, and the additional data stream 430 may include metadata 440. The broadcast content stream 415 may include an audio stream 420 and a video stream 410. When the broadcast content stream 415 and additional data stream 430 are generated, broadcast content stream 415 and additional data stream 430 are transmitted to a receiving apparatus (S403). Here, the metadata 440 may be characterized to include at least one of an indicator 441 indicating whether or not the broadcast content are available for an application of augmenting content, access information 443 of an augmenting content providing apparatus transmitting the area information-based content to the receiving apparatus, a display region information 445 indicating a temporal/spatial region in which the area information-based augmenting content is displayed on the broadcast content , and a basic augmenting content 447 to be output when the area information-based augmenting content corresponding to the area in which the receiving apparatus is located does not exist. Here, the step S403 of transmitting the broadcast content stream 415 and the additional data stream 430 to the receiving apparatus may be characterized to multiplex the broadcast content stream 415 and the additional data stream 430 and transmit the same.

In detail, the broadcast content may be provided through broadcasting like the conventional TV broadcast, or may be provided in the form of a VoD (Video on Demand) according to a viewer's request. In the case of VoD, the broadcast content may be delivered through multicasting according to multiple viewers' requests. The broadcast content transport stream 400 received by the viewer's receiving apparatus may configure one or more video streams 410, one or more audio streams 420, and one or more additional data streams 430 through multiplexing and transmit the same to the viewer. The video stream 410 and the audio stream 420 may include broadcast content-related information, and the additional data stream 430 may include metadata 440 for area information. The metadata 440 may include at least one of the indicator 441, the access information 443 of the augmenting content providing apparatus, the display region information 445, and the basic augmenting content 447. The indicator 441 may indicate whether or not the broadcast content are available for an application of augmenting content. A broadcasts content producer may determine whether to allow for an application of augmenting content, and when an application of augmenting content is allowed, the indicator 441 indicating whether or not the corresponding broadcast content are available for an application of augmenting content may be included in metadata. Thus, when the indicator 441 is checked, whether or not a follow-up step for receiving augmenting content is to be performed may be known. The access information 443 of the augmenting content providing apparatus refers to access information 443 of an augmenting content providing apparatus which transmits area information-based content corresponding to the broadcast content to the receiving apparatus and may include, for example, location information (in the form of URL, URI, or the like in case of the Internet), or the like, of a portal server able to receive area information-based augmenting content. When the location information of a portal server able to receive an area-based information service is omitted, a server previously registered to the receiving apparatus may be used. The display region information 445 may indicate a temporal region and a spatial region in which the augmenting content are displayed on the broadcast content. When advertisement content of a franchise Pizza parlor is assumed, a temporal region may be specified from 15 seconds to 25 seconds, a spatial region may be specified by a character box positioned to be one-tenth of a vertical length of the entire frame at a lower end portion of a frame, and a phone number and a map of a Pizza parlor closest to an area in which the receiving apparatus is located may be displayed. The basic augmenting content 447 to be output when there is no area information-based augmenting content corresponding to the area in which the receiving apparatus is located may be included together. The basic augmenting content 447 may be output as the same information to every area which a corresponding broadcast reaches regardless of an area. For example, when there is no Pizza parlor within a pre-set distance, augmenting content may not be generated and, in this case, the basic augmenting content 447 may be included such that a representative phone number of the Pizza parlor is displayed.

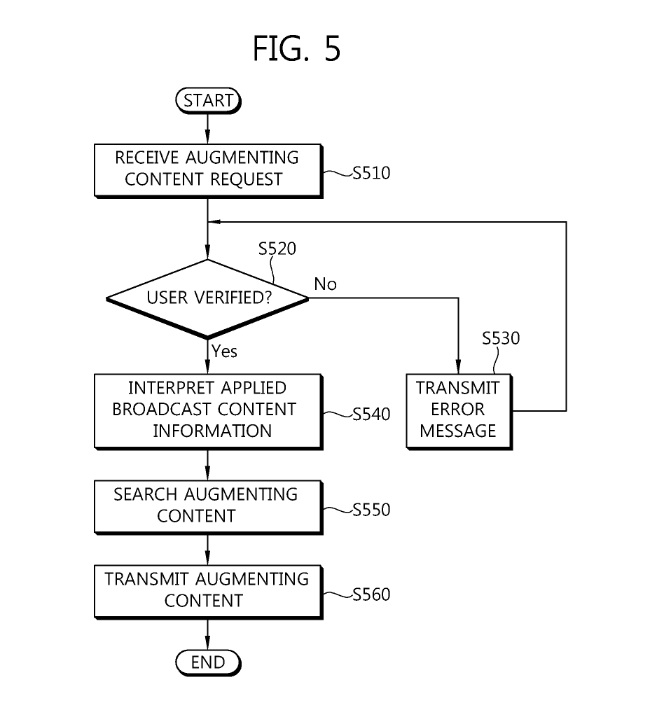

FIG. 5 is a flow chart illustrating a process of an augmenting content providing method according to an embodiment of the present invention.

As shown in FIG. 5, the augmenting content providing method according to an embodiment of the present invention may include an augmenting content request receiving step (S510) of receiving a request for augmenting content based on area information from a receiving apparatus of a viewer, an application broadcast content information interpreting step (S540) of interpreting the request for augmenting content to determine application broadcast content requesting the augmenting content, an augmenting content searching step (S550) of searching area information-based augmenting content with respect to an area in which the receiving apparatus of the determined application broadcast content is located from a storage unit, and an augmenting content transmitting steep (S560) of transmitting the searched augmenting content to the receiving apparatus.

Here, the method may further include a user verifying step (S520) of verifying a user by analyzing log-in information (here, the log-in information may include at least one of a user ID, a password, and an authorization certificate) received from the receiving apparatus and an error transmission step (S530) of transferring an error message to the receiving apparatus when the user verification fails in the user verifying step.

Namely, an augmenting content providing apparatus, such as the content provider 210, the portal operator 223, or the like, for providing an augmenting content service receives a request for augmenting content from the augmenting content receiving apparatus (S510). As for the augmenting content providing apparatus from which the receiving apparatus requests augmenting content, a content provider or a portal may be indicated in metadata of broadcast content or access information of the augmenting content providing apparatus from which augmenting content based on area information are to be retrieved may be stored in a storage device of the receiving apparatus. The user who has made the request is verified (S520) and a user ID, password, authorization certificate, or the like, may be verified. When verification of the user ID fails, an error resulting from the failure of the user verification is returned to the receiving apparatus (S530). When area information is provided for free, user verification may not be performed. When the user is verified, the application broadcast content information interpreting step (S540) of interpreting the request for augmenting content to determine application broadcast content requesting the augmenting content is performed. The application broadcast content refers to target broadcast content to which the area information-based augmenting content are added. The application broadcast content are searched by using a broadcast content ID and an augmenting content ID included in the corresponding broadcast content together (e.g., broadcast content ID-augmenting content ID). A plurality of augmenting content display regions may exist in a single broadcast content. Thus, in order to specify the broadcast content, a broadcast content ID is assigned, and in order to specify augmenting content region as an application target among a plurality of augmenting content that may be applicable on the broadcast content, an augmenting content ID is assigned. Thus, application broadcast content representing whether or not the area information-based augmenting content is applicable to a particular augmenting content display region of the particular broadcast content may be determined based on the broadcast content ID and the augmenting content ID. Thereafter, the augmenting content searching step (S550) of searching the area information-based augmenting content with respect to an area in which the receiving apparatus of the determined application broadcast content is located from a storage unit is performed. When there are augmenting content, the augmenting content are transmitted to the receiving apparatus (S560). The augmenting content may include pertinent metadata. When the augmenting content are registered to a different server, the augmenting content are searched from the server and then transmitted to the receiving apparatus. However, when there are no augmenting content, since augmenting content cannot be transmitted, an error is transmitted.

Here, in the augmenting content searching step (S550), area information-based augmenting content with respect to the area in which the receiving apparatus is located may be searched from the storage unit of the augmenting content providing apparatus and provided, but the area information-based augmenting content may be stored in the storage unit of the receiving apparatus and re-used to thus reduce traffic of the communication network. The area of the receiving apparatus is determined in principle by the augmenting content providing apparatus, but information required for the determination is provided from the side related to the receiving apparatus. When a GPS of a receiving apparatus as a portable terminal is used, a GPS value obtained by the receiving apparatus is transferred to the augmenting content providing apparatus. The augmenting content providing apparatus determines an area of the receiving apparatus (which means that area information-based augmenting content of which area are to be provided to the receiving apparatus) with reference to the GPS value. Here, however, the changing of the GPS value into area information may be directly performed by the receiving apparatus as a portable terminal or a separate server for converting the location of the receiving apparatus as a portable terminal may be utilized in association with the augmenting content providing apparatus. A case of determining a location by using an IP address is the same. The receiving apparatus may determine the area by using an IP address thereof, or a separate server for converting an IP address into an area may be utilized in association with the augmenting content providing apparatus. Of course, the changing of the IP address into an area may be directly performed by the augmenting content providing apparatus. In particular, in order for the receiving apparatus to directly change the GPS value or the IP address into the area, the receiving apparatus is required to have a particular application for performing the function.

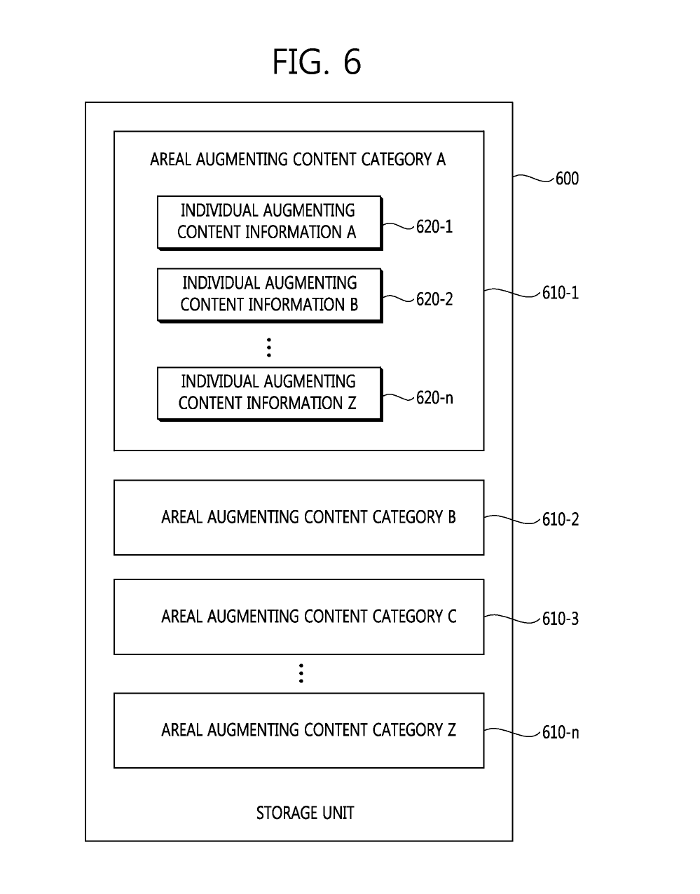

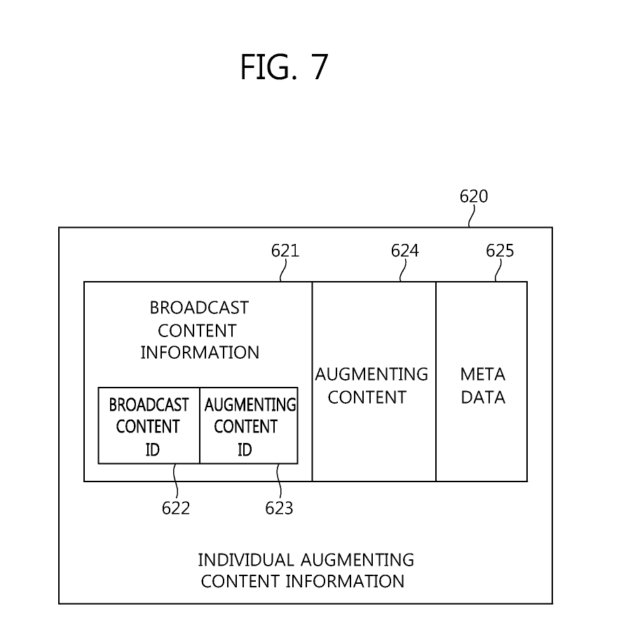

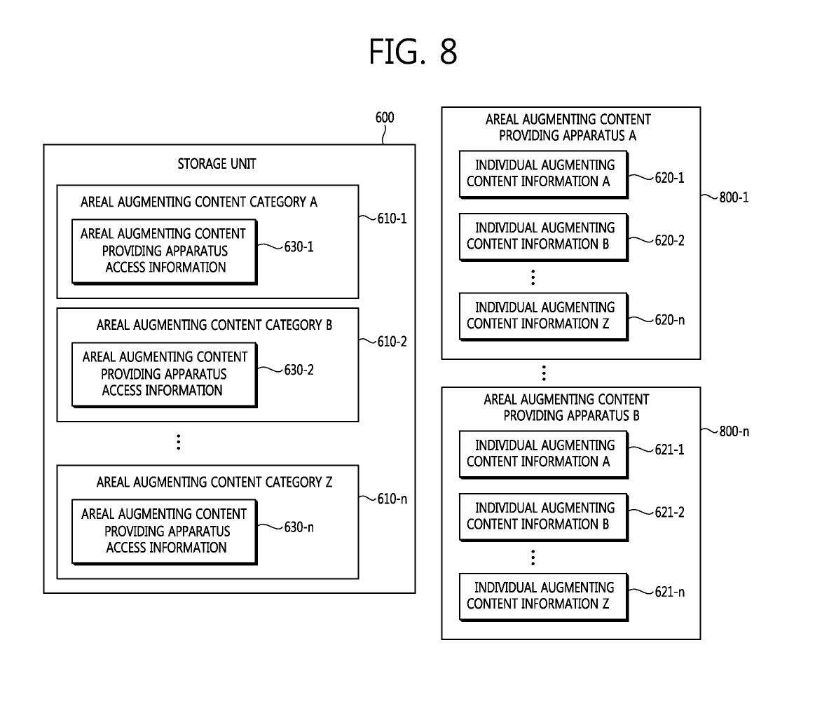

The augmenting content are stored in the storage unit 600 of the augmenting content providing apparatus in various manners. FIG. 6 is a view illustrating the storage unit 600 of the augmenting content providing apparatus for providing augmenting content by areas according to an embodiment of the present invention. FIG. 7 is a detailed view illustrating individual augmenting content information 620 of FIG. 6. FIG. 8 is a view illustrating the configuration of the storage unit 600 when the apparatus of FIG. 6 provides access information 630.

As illustrated in FIGS. 6 and 7, the storage unit 600 includes at least one areal augmenting content category 610 obtained by dividing the area information-based augmenting content according to corresponding areas. One area has an areal augmenting content category 610 corresponding to the area. The areal augmenting content category 610 includes at least one individual augmenting content information 620 belonging to a corresponding area of the areal augmenting content category 610. All the individual augmenting content information a 620-1, individual augmenting content information b 620-2, and individual augmenting content information z 620-n follow the configuration of the individual augmenting content information 620 illustrated in FIG. 7. The individual augmenting content information 620 includes at least one of broadcast content information 621 including a broadcast content ID 622 and an augmenting content ID 623 for identifying broadcast content to which the area information-based augmenting content are applied, area information-based augmenting content 624 applied to the broadcast content, and metadata 625 including information required for outputting the area information-based augmenting content 624. Here, the broadcast content ID 622 is used to discriminate respective broadcast content, and 20-second advertisement broadcast content are also regarded as single broadcast content. As for the augmenting content ID 623, when single broadcast content include a plurality of augmenting content 624, the plurality of augmenting content 624 has each augmenting content ID 623, and this identification number may be shown as a value of a time at which the augmenting content 624 appears after the corresponding broadcast content start. The augmenting content 624 are various types of augmenting content 624 (e.g., a phone number of a user area or an advertisement of the user area) to be provided to the receiving apparatus of the user. Also, the metadata 625, associated with the augmenting content 624, includes information required for outputting the augmenting content 624 or information to be additionally provided to the user. Accordingly, information according to a corresponding area is provided according to a user location. The provided area information may be provided on broadcast content by text, graphics, video, or even broadcast content based on area information.

As shown in FIG. 8, the storage unit 600 includes at least one areal augmenting content category 610 obtained by classifying the area information-based augmenting content by corresponding areas, and at least one of the areal augmenting content category 610 includes access information 630 of an augmenting content providing apparatus 800 providing augmenting content based on a corresponding area information, rather than directly providing individual augmenting content information 620 belonging to a corresponding area of the areal augmenting content category 610 to thereby allow for the use of at least one individual augmenting content information 620 and 621 belonging to a corresponding area of the areal augmenting content providing apparatus 800 stored in the areal augmenting content providing apparatus 800. Here, the access information 630 of the areal augmenting content providing apparatus is information allowing the receiving apparatus to discover the areal augmenting content providing apparatus 800. For example, the access information 630 may be an address (URL or URI in case of the Internet) of a server.

According to circumstances, the storage methods of the augmenting content illustrated in FIGS. 6 through 8 may be mixedly used. The storage unit 600 of the augmenting content providing apparatus may directly provide the area information-based individual augmenting content information 620 according to an area in which the receiving apparatus is located, or may provide access information 630 of the areal augmenting content providing apparatus 800 having area information-based augmenting content according to circumstances. In FIGS. 6 through 8, a case in which area information are configured by two stages is shown, but in case of B area, the B area may be segmented into B1, B2, . . . , Bn and area information-based individual augmenting content information with respect to the areas B1, B2, . . . , Bn may be directly provided or access information for discovering an augmenting content providing apparatus of each area may be provided to allow the receiving apparatus to obtain area information-based individual augmenting content information from the augmenting content providing apparatus of each area.

A different server may be provided to each area and operated as shown in FIG. 8. Besides the two stages and three stages described in FIG. 8, the areal augmenting content providing apparatuses may be further segmented to configure multiple stages. Also, these servers may be operated by a content provider or a portal operator. The individual augmenting content information 620 in FIG. 8 may have the format described in FIG. 7.

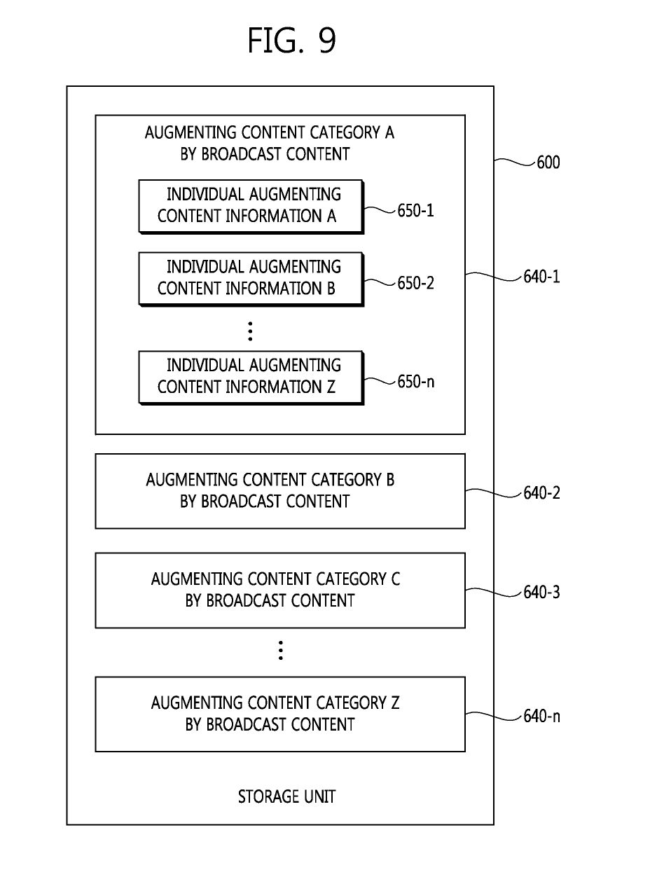

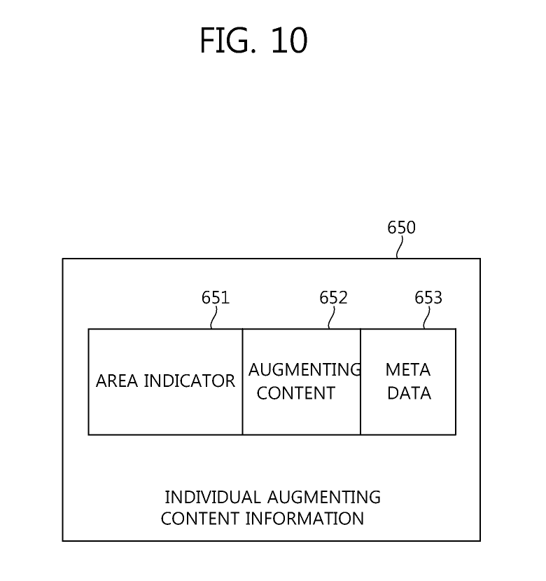

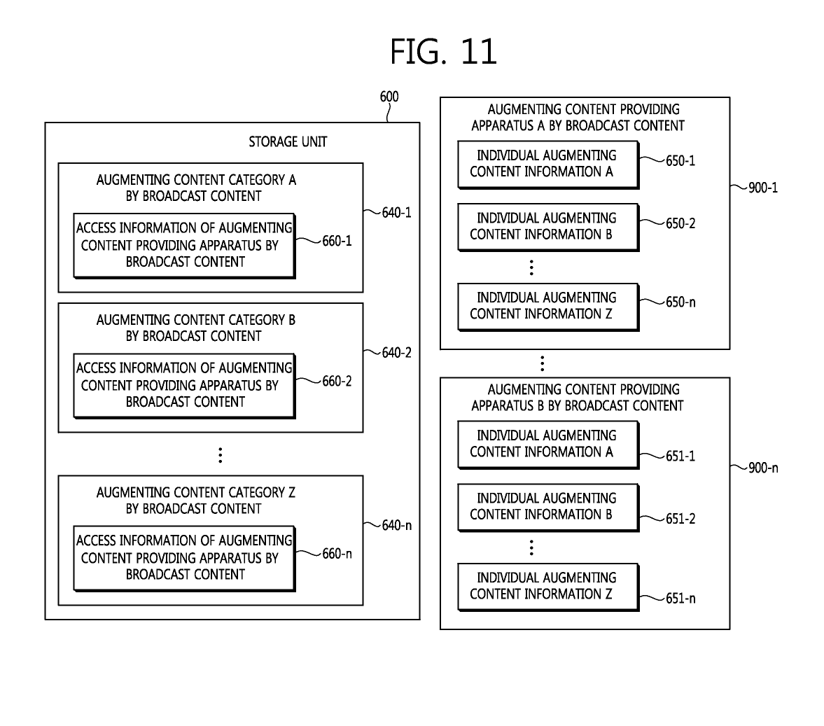

FIG. 9 is a view illustrating a storage unit of an augmenting content providing apparatus for providing augmenting content by broadcast content according to another embodiment of the present invention. FIG. 10 is a detailed view illustrating individual augmenting content information of FIG. 9. FIG. 11 is a view illustrating the configuration of a storage unit when the apparatus of FIG. 9 provides access information.

As shown in FIGS. 9 and 10, the storage unit 600 of the augmenting content providing apparatus may be configured based on respective broadcast content. The storage unit 600 may include at least one augmenting content category 640 by broadcast content obtained by classifying the area information-based augmenting content by broadcast content identified by the broadcast content ID 622 and the augmenting content ID 623. The augmenting content category 640 by broadcast content may include at least one individual augmenting content information 650 with respect to corresponding broadcast content of the augmenting content category 640 by broadcast content. Individual augmenting content information a 650-1, individual augmenting content information b 650-2, and individual augmenting content information z 650-n illustrated in FIG. 9 follow the configuration of the individual augmenting content information 650 illustrated in FIG. 10. Here, the individual augmenting content information 650 may include at least one of an area indicator 651 indicating a corresponding area of the area information-based augmenting content, area information-based augmenting content 652 applied to the area, and metadata 653 including information required for outputting the area information-based augmenting content.

Even when the storage unit 600 of the augmenting content providing apparatus includes at least one augmenting content category 640 by broadcast content obtained by classifying the area information-based augmenting content according to broadcast content as shown in FIG. 11, the augmenting content category 640 by broadcast content may include access information 660 of augmenting content providing apparatus 900 by broadcast content providing augmenting content with respect to corresponding broadcast content rather than directly providing individual augmenting content information 650 with respect to corresponding broadcast content of the augmenting content category by the broadcast content, to thereby allow the individual augmenting content information 650 and 651 stored in the augmenting content providing apparatus 900 by the broadcast content to be used.

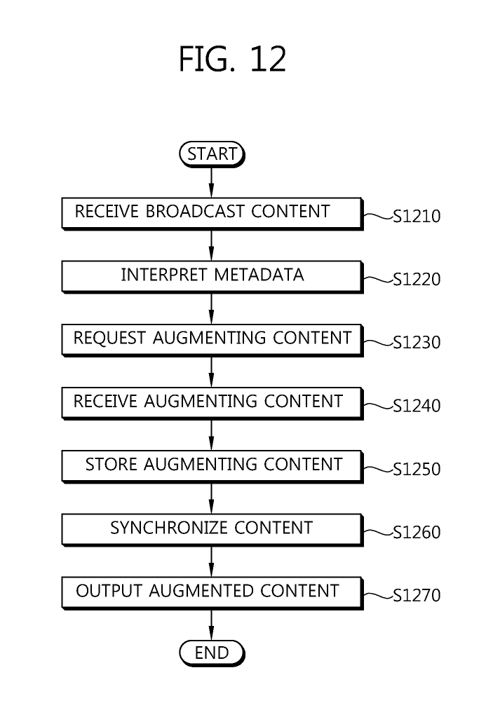

FIG. 12 is a flow chart illustrating a process of an augmenting content receiving method according to an embodiment of the present invention.

As shown in FIG. 12, an area information-based augmenting content receiving method according to an embodiment of the present invention includes a broadcast content receiving step (S1210) of receiving broadcast content and metadata from a broadcast content providing apparatus, a metadata interpreting step (S1220) of interpreting the metadata 440 related to the broadcast content and checking an indicator 441, an augmenting content requesting step (S1230) of requesting augmenting content from an augmenting content providing apparatus by using the access information 443 of the augmenting content providing apparatus included in the metadata 440 when the indicator 441 exists, an augmenting content receiving step (S1240) of receiving the augmenting content from the augmenting content providing apparatus, a content synchronizing step (S1260) of synchronizing the broadcast content received in the broad content receiving step (S1210) and the augmenting content received in the augmenting content receiving step (S1240), and an augmenting content output step (S1270) of outputting the synchronized augmenting broadcast content to a temporal/spatial region on broadcast content corresponding to the display region information 445 included in the metadata 440 or transmitting the display region information 445 to a separate output device.

Here, in order to synchronize the broadcast content and the augmenting content, the broadcast content receiving step (S1210) may be characterized to delay reproducing of the received broadcast content and the content synchronizing step (S1260) may be characterized to check reception of augmenting content corresponding to the delayed broadcast content, complete synchronization, and then, start reproducing of the delayed broadcast content.

Also, the an area information-based augmenting content receiving method according to an embodiment of the present invention may further include an augmenting content storage step (S1250) of storing the received augmenting content following the augmenting content receiving step (S1240).

In detail, when the receiving apparatus receives the broadcast content in the broadcast content receiving step (S1210), the receiving apparatus performs demodulation/error correction, and the like, and then, when the broadcast content providing apparatus has multiplexed the broadcast content, the receiving apparatus demultiplexes the broadcast content. When the broadcast content are demultiplexed, the broadcast content are split into an audio stream, a video stream, and an additional data stream, and the receiving apparatus decodes the audio stream and the video stream. Audio and video may be decoded according to encoding schemes, separately, or may be decoded together. Subsequently, the receiving apparatus may buffer the broadcast content in order to synchronize the broadcast content and augmenting content. Namely, since a certain time is required for receiving area information-based augmenting content via a communication network based on metadata, the receiving apparatus may delay reproducing of the broadcast content until when augmenting content are completely received in order to synchronize the broadcast content and the augmenting content, or metadata related to augmenting content of next broadcast content is previously sent while current broadcast content are being broadcast to allow the receiving apparatus to adjust a schedule to receive augmenting content from the augmenting content providing apparatus and synchronize the same. Meanwhile, in the metadata interpreting step (S1220), the metadata is interpreted and corresponding augmenting content are requested (S1230). As for the interpreting the metadata, when the transmission side has encoded the metadata, the reception side should perform decoding accordingly. According to interpretation of the metadata, required augmenting content are requested (S1230) and augmenting content are resultantly received (S1240). The received augmenting content may be stored as necessary (S1250). When augmenting content should be secured according to interpretation of metadata, augmenting content should be requested and received, but if required augmenting content have already been stored in the receiving apparatus, the requesting and receiving may be internally process within the augmenting content receiving apparatus. When augmenting content are acquired, the augmenting content are synchronized with audio/video of the broadcast content so as to be output. According to the style of the augmenting content, the augmenting content may be added to audio of the broadcast content so as to be output, may be added to video of the broadcast content so as to be output, or may be output in a different type of media, and also may be output one or more of the audio, video, and any other media. Any other media may be, for example, vibration, wind, or scent, and the like, and the augmenting content may be expressed in various formats. An output method of these various media may be adjusted by a viewer. Namely, a viewer may adjust the degree of an output with respect to the same information just the way he or she adjusts brightness of a screen or the size of a sound of a speaker. When a golf course is viewed by augmenting broadcast content, a viewer may view the course at various angles according to his or her inputs.

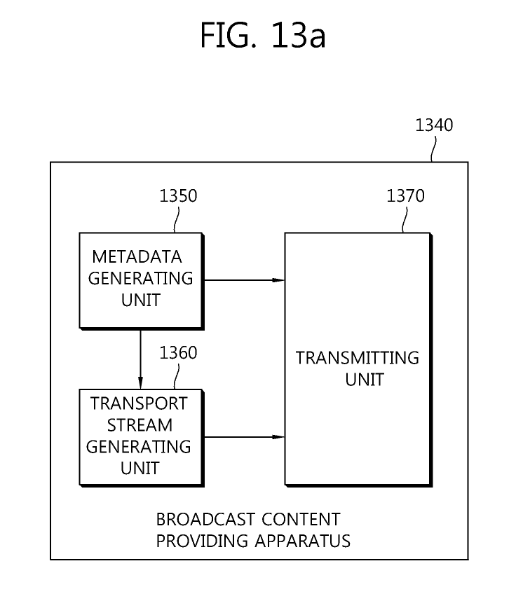

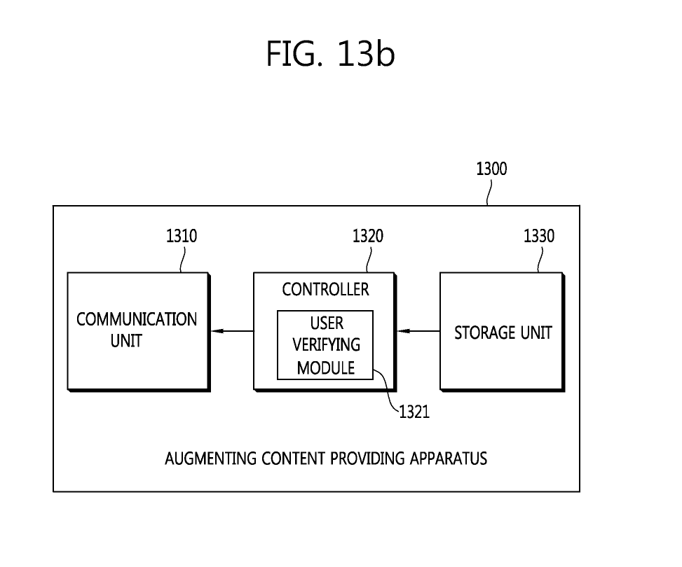

FIG. 13A is a view illustrating a configuration of a broadcast content and metadata providing apparatus according to an embodiment of the present invention. As illustrated in FIGS. 13A and 4, a broadcast content providing apparatus 1340 according to an embodiment of the present invention includes a metadata generating unit 1350 generating metadata for displaying area information-based augmenting content related to broadcast content, a transport stream generating unit 1360 generating a broadcast content stream 415 based on the broadcast content and generating an additional data stream 430 based on the metadata 440, and a transmitting unit 1370 transmitting the broadcast content stream 415 and the additional data stream 430 to the receiving apparatus. Here, the metadata 400 may include at least one of the indicator 441, the access information 443 of the augmenting content providing apparatus, the display region information 445, and the basic augmenting content 447. Here, the transmitting unit 1370 may be characterized to multiplex the broadcast content stream 415 and the data stream 430 and transmit the same.

FIG. 13B is a view illustrating a configuration of an augmenting content providing apparatus according to an embodiment of the present invention.

As shown in FIG. 13B, an augmenting content providing apparatus 1300 according to an embodiment of the present invention includes a communication unit 1310 receiving an area information-based augmenting content request from a receiving apparatus of a viewer and transmitting searched augmenting content to the receiving apparatus under the control of a controller 1320, the controller 1320 interpreting the augmenting content request to determine applied broadcast content requesting the augmenting content and searching a storage unit 1330 for area information-based augmenting content with respect to an area in which the receiving apparatus of the determined applied broadcast content is located, and the storage unit 1330 storing at least one area information-based augmenting content corresponding to the broadcast content and a broadcasting area.

Here, the controller 1320 may include a user verifying module 1321 for receiving log-in information (here, the log-in information may include at least one of a user ID, a password, and an authorization certificate) from the receiving apparatus and analyzing the log-in information to verify a user, and when the user verifying module 1321 fails to verify the user, the user verifying module 1321 may transmit an error message to the receiving apparatus.

Here, as illustrated in FIGS. 6 through 1 land as described above with respect to the augmenting content providing method, the storage unit 1330 configures the areal augmenting content category 610 regarding augmenting content to provide the individual augmenting content information 620 or the access information 630 of the areal augmenting content providing apparatus, or configure augmenting content category 640 by broadcast content to provide individual augmenting content information 650 or access information 660 of the augmenting content providing apparatus by broadcast content.

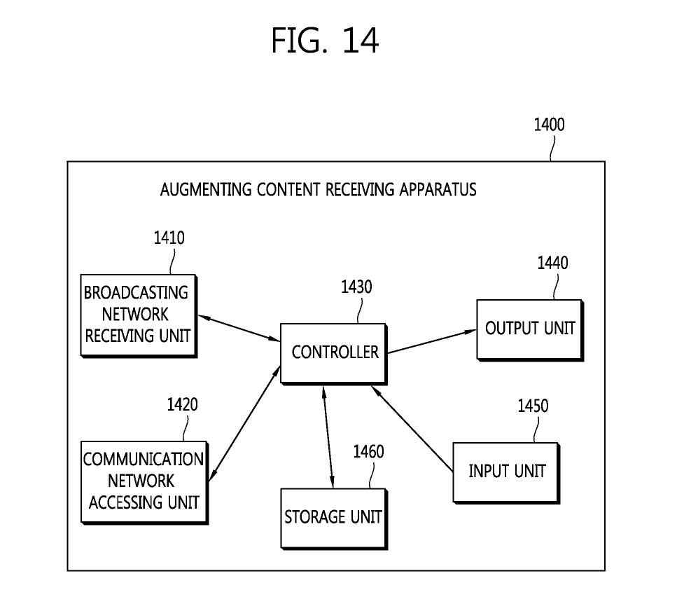

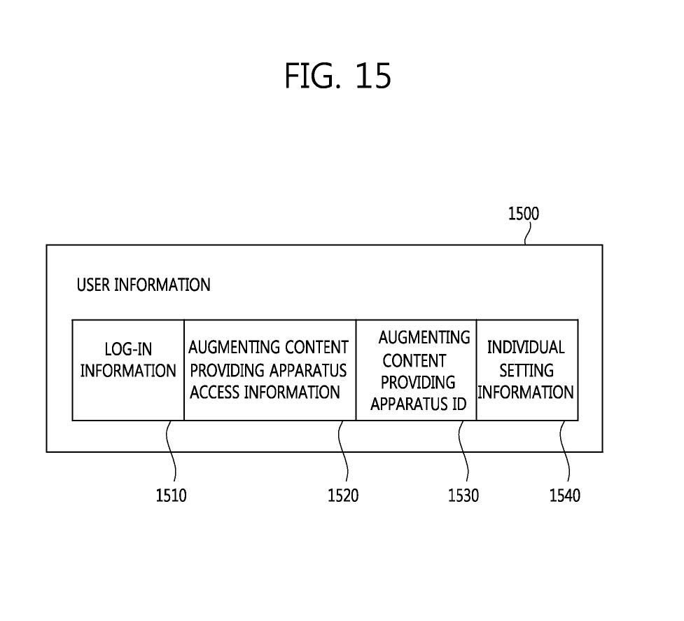

FIG. 14 is view illustrating a configuration of an augmenting broadcast content receiving apparatus according to an embodiment of the present invention. FIG. 15 is a view illustrating a configuration of user information applied to a storage unit and an input unit of FIG. 14.

As shown in FIG. 14, an area information-based augmenting content receiving apparatus 1400 according to an embodiment of the present invention includes a broadcasting network receiving unit 1410 receiving broadcast content and metadata via a broadcasting network from a broadcast content providing apparatus and transmitting the same to a controller 1430 under the control of a controller 1430, a communication network accessing unit 1420 receiving augmenting content through a connection of a wired/wireless communication network from the augmenting content providing apparatus 1300 and transmitting the same to the controller 1430 under the control of the controller 1430, the controller 1430 interpreting the metadata related to the broadcast content to check an augmenting content indicator, requesting augmenting content from the augmenting content providing apparatus 1300 by using access information of the augmenting content providing apparatus 1300 included in the metadata when the augmenting content indicator exists, and synchronizing the broadcast content and the augmenting content, and an output unit 1440 outputting the synchronized broadcast content and the augmenting content to a temporal/spatial region on the broadcast content corresponding to display region information included in the metadata or transmitting the display region information to a separate output device under the control of the controller 1430.

In detail, the broadcasting network receiving unit 1410 has a protocol layer capable of receiving broadcast content transmitted as a digital broadcast, and the controller 1430 interprets the broadcast content and other information transmitted through the broadcasting network receiving unit 1410 to determine whether or not the metadata is required to be processed, and processes the metadata. Augmenting content are received through the communication network accessing unit 1420 according to the interpretation of the metadata. The communication network accessing unit 1420 has a function of processing a protocol required for accessing the wired/wireless communication network.

The controller 1430 performs matching/synthesizing/synchronization on the received augmenting content with respect to the broadcast content and outputs the same to each media. The function of matching, synthesizing, and synchronizing the broadcast content and augmenting content may be separated from the controller 1430 and realized as a separate function block. The output unit 1440 may be divided to be configured as a video control and output unit, an audio control and output unit, and other media control and output unit. The video control and output unit may handle a function of outputting video information of broadcast content and that of augmenting content together, the audio control and output unit may handle a function of audio information of the broadcast content and that of augmenting content together, and other media control and output unit may handle a function of outputting other media information of augmenting content. The input unit 1450 may process a user input in the augmenting broadcast receiving apparatus and process a user motion or various input methods, as well as a conventional input based on a remote controller.

Here, in order to synchronize the broadcast content and the augmenting content, the controller 1430 may delay reproducing of the received broadcast content, check reception of augmenting content corresponding to the delayed broadcast content, completely synchronize the same, and resume reproducing of the delayed broadcast content.

FIG. 15 is a view showing a configuration of user information 1500 applied to the storage unit 1460 and the input unit 1450.

As shown in FIG. 15, the augmenting content providing apparatus 1300 may further include an input unit 1450 for inputting user information 1500 including at least one of log-in information 1510, augmenting content providing apparatus access information 1520, an augmenting content providing apparatus ID 1530, and individual setting information 1540, and a storage unit 1460 storing at least one of the log-in information 1510, the augmenting content providing apparatus access information 1520, the augmenting content providing apparatus ID 1530, and the individual setting information 1540. The storage unit 1460 has a card type storage unit having an RFID function, and the input unit 1450 serves as a mounting cradle of the RFID function to bring the storage unit 1460 into contact with the input unit 1450 to allow for inputting of the user information.

A function related to user log-in will be described in detail. Besides devices related to log-in described hereinafter, the input unit 1450 may include various input devices using a marker or a sensor, an interface related to processing them, and the like. A log-in function of the input unit 1450 may be used by a plurality of users. Typing using a keyboard, a facial recognition, iris scan, or the like, may be possibly included. Various types of keyboards may be provided, and one or more cameras having various shapes and standards may also be provided. In particular, as mentioned above, a card mounting cradle for using RFID for a simple log-in may be provided. The user may log in by simply placing a card having an RFID function on the cradle. Each user may have one or more cards having an RFID function, and each card includes the user information 1500. Here, the card may have the same size as a remote controller of a receiving apparatus such that the user can fix the card and brings the remote controller instead. In particular, in order to allow a plurality of users to use a single receiving apparatus, a plurality of card mounting cradles may be used in association with the receiving apparatus, or a single card mounting cradle may be provided such that a plurality of cards are mounted thereon.

Each user has user information 1500. First, user's log-in information 1510 may have a user's log-in name or a password. When facial recognition, iris scan, fingerprint recognition, or the like, is used by using a camera, feature information such as face/iris/fingerprint, or the like, may be kept in storage as log-in information 1510. Also, the user information 1500 may have access information 1520 (URL or URI in case of the Internet) of the augmenting content providing apparatus accessed and used by a user having the corresponding log-in information 1510 and an ID of the corresponding augmenting content providing apparatus. The user information 1500 may include access information 1520 of one or more augmenting content providing apparatuses and the ID 1530 of a corresponding augmenting content providing apparatus with respect to single log-in information 1510. Namely, a single user may use a plurality of augmenting content providing apparatuses. When the user performs log-in by using a card, only the log-in information 1510 may be stored in the card, or the access information 1520 of the augmenting content providing apparatus and the ID of a corresponding augmenting content providing apparatus may also be stored together so that the user can use the single card for a different receiving apparatus.

Besides, the user information may include individual setting information 1540. For example, the individual setting information 1540 may include disposition of information on a screen of a receiving apparatus, brightness of the screen, the size of a sound, a basic access broadcasting channel, whether or not an augmenting broadcast is used, frequently used application broadcast content, and the like.

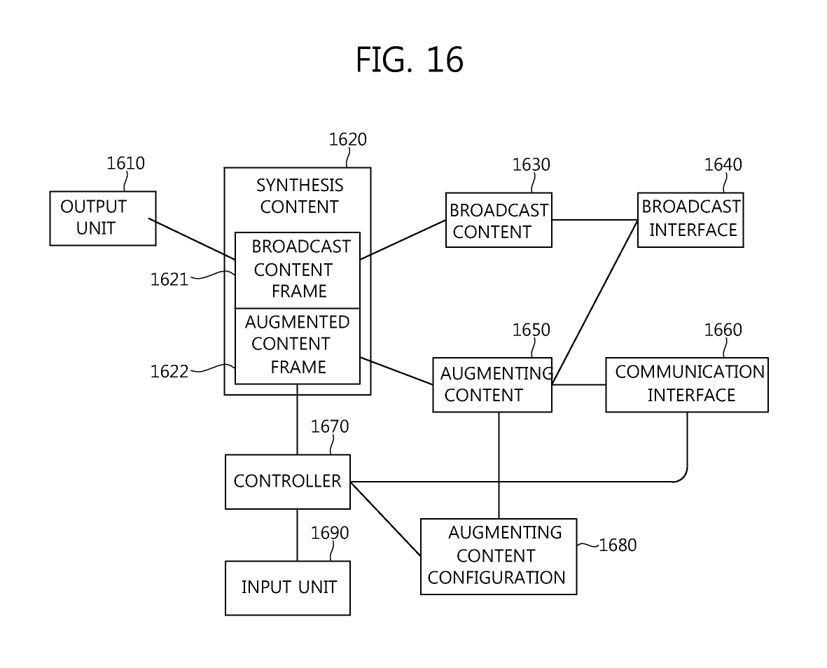

FIG. 16 is a view illustrating a configuration of an apparatus that synthesizes broadcast content and augmenting content and outputs the same. Augmenting content and broadcast content may be output different output devices according to an embodiment, but in a case, certain augmenting content may be required to be synthesized and sent to a single output device. For example, when augmenting content are an image, the augmenting content are synthesized with existing broadcast content so as to be sent to a single screen. Of course, the broadcast content and the augmenting content may be output to different screens.

As shown in FIG. 16, broadcast content 1630 continue to be accumulated in real time through a broadcast interface 1640. Here, real time refers to receiving broadcast content and demodulating/decoding the received broadcast content, and it does not mean a concept of live broadcasting. Augmenting content 1650 are received through a broadcast interface 1640 or a communication interface 1660. Here, the augmenting content 1650 include metadata related to an output of augmenting content. Augmenting content setting 1680 is a value previously set for an output method of the augmenting content 1650, which is used in generating synthesis content 1620. Also, the augmenting content setting 1680 information is corrected according to metadata included in the augmenting content 1650. The synthesis content 1620 synthesize a unit of each of the broadcast content 1630 and the augmenting content 1650 and sends the same to an output unit 1610. For example, in case of an image, the synthesis content 1620 may synthesize broadcast content and augmenting content corresponding to one frame of an image and send the same to the output unit 1610. A controller 1670 controls the synthesizing of the content according to the augmenting content setting 1680, and changes a synthesizing method of the synthesis content 1620 according to a user input through an input unit 1690. Here, if the synthesizing method in this case conflicts with a synthesizing method with a value set in the initial augmenting content setting 1680, a synthesizing method according to a user input through the input unit 1690 is preferentially applied. For example, in case of an image, a configuration in which when augmenting content are output to broadcast content, the broadcast content have a transparent format so as to be visible under the augmenting content may be changed to a scheme in which the augmenting content are output to completely cover the broadcast content such that the broadcast content are invisible. Also, such a change of setting may be automatically stored in the setting of the augmenting content of the augmenting content setting 1680 without a user input, or the changed setting may be applied only while the controller 1670 performs controlling currently, rather than being stored, and the original setting stored in the augmenting content setting 1680 may be applied to be used for a new session (e.g., when a channel of a receiving apparatus is changed or power is reset) later.

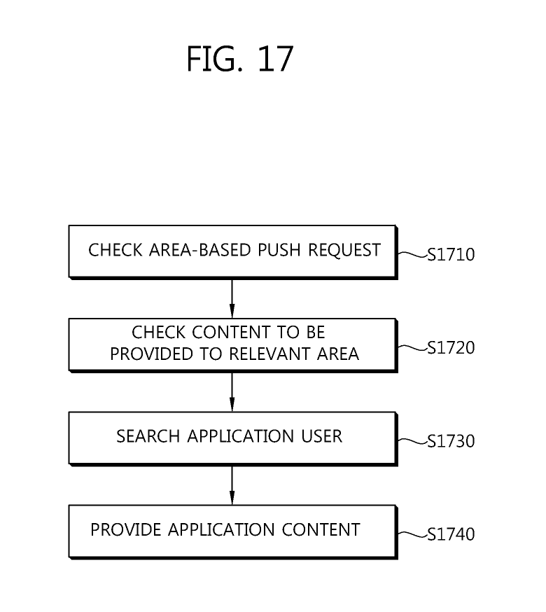

FIG. 17 is a flow chart illustrating a process of a method of providing additional content based on area information. Here, additional content may be augmenting content related to broadcast content, or may be simple additional content that do not have a direct connection with broadcast content. For example, when a soap opera is broadcast through a certain channel, the additional content may be content able to augmenting viewing of the soap opera as current broadcast content such as a scene related to a corresponding area of the soap opera, the cast, shooting, or the like, or may be general content such as weather of a corresponding area, market information of the area, or the like, unrelated to the soap opera as the current broadcast content. The additional content are provided to a user of the corresponding area by a content provider or a portal operator.

As shown in FIG. 17, first, after a step (S1710) of checking an area-based push request of a content provider or a portal operator, a step (S1720) of checking content to be provided to a corresponding area is performed. In the area-based push request checking step (S1710), the National Emergency Management administering the corresponding area may request a push of information such as weather, or the like, to be provided to the corresponding area, or the push request may be an internal request determined to provide information to the corresponding area within a system of the content provider or the portal operator. In an application user searching step (S1730), a user of the corresponding area is searched. Namely, a user who has logged in to a server of the content provider or the portal operator is searched. The step (S1720) of checking content to be provided to the corresponding area and the step (S1730) of searching an application user may be interchanged in order. Subsequently, an application content providing step (S1740) is performed to provide additional content to be provided to searched users. Here, in case of augmenting content related to broadcast content, the additional content are transmitted by using two methods. Since users of channels are different, each user is checked through a communication network and the additional content are transmitted only to a receiving apparatus which views the corresponding channel, or the additional content may be delivered to every subscriber in the area by using a broadcast function or a multicast function of a communication network by the content provider or the portal operator, so that the additional content may be output when each receiving apparatus is viewing the corresponding channel.

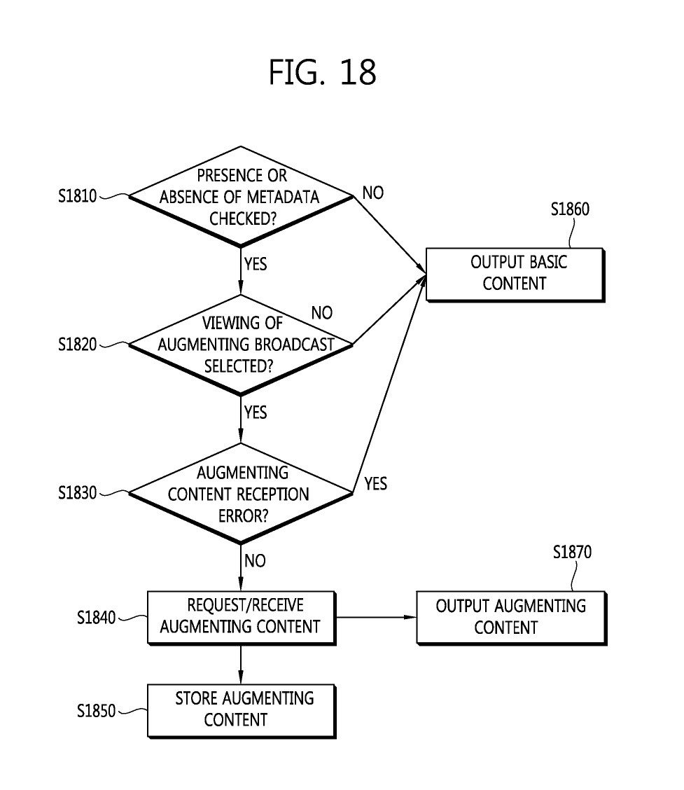

FIG. 18 is a flow chart illustrating a process of a method of determining whether to output augmenting broadcast content according to reception of metadata.

Broadcast content received through the broadcast content receiving step (S1210) in FIG. 12 are demultiplexed and the presence or absence of metadata is checked in a metadata presence and absence checking step (S1810). When metadata itself does not exist or when a viewer does not select viewing of augmenting broadcast in an augmenting broadcast viewing selecting step (S1820) although augmenting content exist in the metadata, only broadcast content, rather than augmenting content, are output (S1860). The broadcast content are included in broadcast content or metadata delivered through a broadcasting network. Even when area-based augmenting content as indicated in the metadata cannot be obtained due to an augmenting content reception error (S1830), only broadcast content are output. In a broadcast content output step (S1860), when information related to an area is not output to the broadcast content, only the broadcast content are output. When the presence of augmenting content is expressed, augmenting content are requested and received (S1840). Augmenting broadcast content may be retrieved from an auxiliary storage device of a receiving apparatus. When the corresponding augmenting broadcast content are required to be stored, the corresponding augmenting broadcast content may be stored and re-used later (S1850). When augmenting content are received, the augmenting content are output after performing a synchronization process (S1870).

Here, the metadata may be generally delivered in broadcast content so as to be received, but also, the metadata may be included in EPG information providing information regarding a schedule of broadcast content so as to be delivered. Namely, when the metadata is included in the EPG schedule broadcast content information and transmitted, the receiving apparatus may select whether to view augmenting broadcast in selecting broadcast content desired to be viewed by itself, whereby the metadata set in the EPG schedule broadcast content may be delivered to the receiving apparatus and the receiving apparatus may first receive the relevant augmenting content.

According to the broadcast content and metadata providing method and apparatus, the augmenting content providing method and apparatus, and the augmenting broadcast content receiving method and apparatus, when broadcast content are broadcast, indication for including area information in metadata is sent together, and a receiving apparatus obtains augmenting content related to information regarding a corresponding area in which the receiving apparatus is located, and outputs the augmenting content when the broadcast content are output, thereby providing specific information specialized according to an area of a viewer.

Thus, the viewer can conveniently receive area information-based augmenting content in the form of large capacity multimedia including a graphic image, a video, or the like, without performing searching, and an enterprise based on the corresponding area can deliver information and an advertisement to specific consumers, and a broadcast operator can make an advertisement profit and an additional profit by providing paid content.

While the present invention has been shown and described in connection with the embodiments, it will be apparent to those skilled in the art that modifications and variations can be made without departing from the spirit and scope of the invention as defined by the appended claims.

What is claimed is:

1. A method of providing augmenting content, the method comprising:
a step of receiving an augmenting content request requesting area information-based augmenting content from a receiving apparatus;
a step of checking broadcast content information for which said requested augmenting content is to be applied by interpreting said augmenting content request;
an augmenting content searching step of searching a storage unit for said area information-based augmenting content with respect to an area in which said receiving apparatus is located based on said checked applying broadcast content information; and
an augmenting content transmitting step of transmitting said searched augmenting content to said receiving apparatus.

2. The method of claim 1, further comprising:
a user verifying step of receiving log-in information from said receiving apparatus and analyzing said log-in information to verify a user, said log-in information including at least one of a user ID, a password, and an authorization certificate; and
an error transmitting step of transferring an error message to said receiving apparatus when the user verification fails in said user verifying step.

3. The method of claim 1, wherein said storage unit includes at least one areal augmenting content category classifying said area information-based augmenting content by areas, and
said areal augmenting content category includes at least one individual augmenting content information belonging to a corresponding area of the areal augmenting content category, and
said individual augmenting content information includes at least one of:
broadcast content information including a broadcast content ID for identifying said broadcast content to which said area information-based augmenting content are to be applied, and augmenting content ID;
area information-based augmenting content applied to said broadcast content; and
metadata including information required for outputting said area information-based augmenting content.

4. The method of claim 1, wherein said storage unit includes at least one areal augmenting content category classifying said area information-based augmenting content by areas, and
at least one of said areal augmenting content categories includes access information of an areal augmenting content providing apparatus that provides corresponding area information-based augmenting content, and
said areal augmenting content providing apparatus comprises at least one individual augmenting content information belonging to a corresponding area of said areal augmenting providing apparatus, and
said individual augmenting content information includes at least one of:
broadcast content information including a broadcast content ID for identifying said broadcast content to which said area information-based augmenting content are to be applied, and augmenting content ID;
area information-based augmenting content applying to said broadcast content; and
metadata including information required for outputting said area information-based augmenting content.

5. The method of claim 1, wherein said storage unit includes at least one augmenting content category of broadcast content classifying said area information-based augmenting content by broadcast content identified through a broadcast content ID and an augmenting content ID, and
said augmenting content category of broadcast content includes at least one individual augmenting content information with respect to corresponding broadcast content of said augmenting content category of broadcast content, and
said individual augmenting content information includes at least one of:
an area indicator indicating a corresponding area of said area information-based augmenting content;
area information-based augmenting content to be applied to said area; and
metadata including information required for outputting said area information-based augmenting content.

6. A method of receiving augmenting content based on area information, the method comprising:
a step of receiving broadcast content and metadata from a broadcast content and metadata providing apparatus;
a metadata interpreting step of interpreting said received metadata to check an indicator indicating such that said broadcast content applies said augmenting content;
an augmenting content requesting step of requesting augmenting content from an augmenting content providing apparatus based on access information of augmenting content providing apparatus included in said metadata when said indicator exists;
an augmenting content receiving step of receiving said augmenting content from said augmenting content providing apparatus;
a content synchronizing step of synchronizing said broadcast content received in said broadcast content receiving step and said augmenting content received in said augmenting content receiving step; and
a content output step of outputting said synchronized broadcast content and augmenting content to a temporal/spatial region corresponding to a display region information included in said metadata or transmitting said display region information to a separate output device.

7. The method of claim 6, wherein in order to synchronize said broadcast content and said augmenting content, reproducing of said received broadcast content is delayed in said broadcast content receiving step, and in said content synchronizing step, receiving of augmenting content corresponding to said delayed broadcast content is confirmed, synchronization is completed, and then, said delayed broadcast content starts to be reproduced.

8. The method of claim 6, further comprising:
an augmenting content storing step of storing said received augmenting content, after said augmenting content receiving step.

9. An apparatus of providing augmenting content, the apparatus comprising:
a communication unit receiving an augmenting content request for requesting area information-based augmenting content from a receiving apparatus of a viewer and transmitting searched area information-based augmenting content to said receiving apparatus under the control of a controller;
a controller interpreting said augmenting content request to check broadcast content for which said requested area information-based augmenting content is to be applied, and searching a storage unit for said area information-based augmenting content with respect to an area in which said receiving apparatus is located based on said checked applying broadcast content information; and
a storage unit storing said broadcast content and at least one area information-based augmenting content corresponding to the area in which said receiving apparatus is located.

10. The apparatus of claim 9, wherein the controller includes:
a user verifying module of receiving log-in information from said receiving apparatus and analyzing said log-in information to verify a user, said log-in information including at least one of a user ID, a password, and an authorization certificate,
wherein when said user verifying module fails to verity the user, said user verifying module transfers an error message to said receiving apparatus.

11. An apparatus of receiving area information-based augmenting content, the apparatus comprising:
a broadcasting network receiving unit receiving broadcast content and metadata via a broadcasting network from a broadcast content providing apparatus and providing the same;
a communication network accessing unit receiving augmenting content through a connection of a wired/wireless communication network from an augmenting content providing apparatus and providing the same;
a controller interpreting said received metadata to check an indicator indicating such that said broadcast content applies said augmenting content, controlling said communication network accessing unit to request said augmenting content from an augmenting content providing apparatus based on access information of said augmenting content providing apparatus included in said metadata when said augmenting content indicator exists, and synchronizing said broadcast content and said augmenting content; and
an output unit outputting said synchronized broadcast content and augmenting content to a temporal/spatial region on said broadcast content corresponding to display region information included in said metadata or transmitting said display region information to a separate output device under the control of the controller.

12. The apparatus of claim 11, wherein said controller delays reproducing of said received broadcast content in order to synchronize said broadcast content and said augmenting content, checks receiving of augmenting content corresponding to said delayed broadcast content, completes synchronization of said broadcast content and said augmenting content, and then, resumes reproducing of said delayed broadcast content.

13. The apparatus of claim 11, further comprising:
an input unit for inputting user information including at least one of log-in information, access information of an augmenting content providing apparatus, an ID of an augmenting content providing apparatus, and individual setting information; and
a storage unit storing at least one of said log-in information, said access information of an augmenting content providing apparatus, said ID of an augmenting content providing apparatus, and said individual setting information.
